(19) United States
(12) Patent Application Publication
(10) Pub. No.: US 2011/0088573 A1
(43) Pub. Date: Apr. 21, 2011

(54) METHOD AND SYSTEM FOR PRINTING BY CAPILLARY EMBOSSING

(76) Inventor: Joseph M. JACOBSON, Newton, MA (US)

(21) Appl. No.: 12/886,675

(22) Filed: Sep. 21, 2010

Related U.S. Application Data
(60) Provisional application No. 61/277,865, filed on Sep. 29, 2009.

(51) Int. Cl. B44B 5/00; B31F 1/07; B42D 15/00

(52) U.S. Cl. 101/4; 101/32; 283/62

(57) ABSTRACT

A method of printing is disclosed. The method comprises embossing a capillary structure onto a receiving layer, and depositing a liquid material to fill the capillary structure.

### RELATED APPLICATION

This application claims the benefit of priority from U.S. Provisional Patent Application No. 61/277,865 filed Sep. 29, 2009, the contents of which are incorporated by reference as if fully set forth herein.

### FIELD AND BACKGROUND OF THE INVENTION

The present invention, in some embodiments thereof, relates to printing and, more particularly, but not exclusively, to printing by capillary embossing.

Currently, there is great interest in producing various circuits such as radio frequency ID tags and electronic display driver chips at costs lower than what can be enabled using conventional photolithographic production means. One approach is the idea of printed electronics in which a set of functional material inks including metals, insulators and semiconductors are printed onto a substrate at high speed in order to constitute an electronic circuit. A number of examples have been demonstrated including printed transistors using both organic semiconductors (Bell Laboratories, Philips Laboratories (Polymervision), PlasticLogic Ltd.) and inorganic semiconductors (MIT—Jacobson Group, Kovio, Epson). Printing techniques have included ink jet printing, offset liquid embossing and gravure printing. These printing techniques comprise two categories, all-additive printing, which only puts functional material where it is needed, and surface-coating based printing, which first deposits a uniform layer of functional ink over a large surface and then patterns the uniform layer. The all-additive approach includes ink jet printing, and the surface-coating approach includes gravure and offset liquid embossing.

### SUMMARY OF THE INVENTION

Several disadvantages of conventional printing approaches have been recognized by the present inventor. Surface-coating based printing is wasteful of ink which increases expense. In addition, for some of these techniques (e.g., gravure) it is difficult to achieve high resolution (below 5 microns) over large areas and/or assure that areas which are not meant to have ink are free of contamination. All-additive printing is successful in only depositing material where it is needed, however it suffers from low resolution (typically not finer than 10 microns). This limits considerably the overall speed of the fabricated electronic circuits since the switching speed of a transistor circuit is dependent on the spacing between the source and the drain electrodes of the transistor. Practically speaking, this makes it difficult to fabricate efficient electronic display driver circuits and higher frequency radio frequency ID tags using ink jet.

The present inventor discovered that embossing process can be utilized for printing.

An embossing process such as the process used to form DVD disks (e.g., the DVD6) is an efficient means of pattern production of small-size features. The process is currently being employed by companies like Molecular Imprints Corporation. The embossing process has heretofore been utilized for making masks in the field of nanoimprint lithography and step and flash lithography. It is recognized by the present inventor that these processes suffer from the need to etch back the imprinted mask after embossing and then to carry out the normal steps of deposition and mask etch, leading to very little improvement of economics, particularly of circuit production. In addition, conventional embossing approaches require many environmentally damaging steps similar to those present in normal photolithography.

The art fail to teach all-additive printing which utilizes embossing. Some embodiments of the present invention are concerned with printing technique which can be used for fabricating high resolution printed electronics circuits. In some embodiments of the present invention the printing is an all-additive printing.

As used herein, “all-additive printing” refers to a process in which materials are arranged and formed into a final printed product without subsequent material removal steps.

The all-additive process is contrary to typical semiconductor fabrication methods which entail deposition of material followed by selective removal of portions of the material using photolithographic or other mask-type techniques. One advantage of the all-additive process of the present embodiments is that it results in reduced waste material and fewer processing steps.

The printed product of the present embodiments is preferably a functional product, such as, but not limited to, an electronic component, or, more preferably a plurality of electronic components collectively forming a functional electrical circuit.

In some embodiments of the present invention the printing method comprises embossing structures into a receiving layer; and subsequently depositing, e.g., by means of ink jetting, a liquid into the structures. In some embodiments of the invention the first liquid is cured to form a solid layer capable of withstanding high temperature.

In some embodiments of the present invention the structures embossed in the first liquid include at least one capillary structure, more preferably a plurality of capillary structures.

As used herein “capillary structure” refers to a passageway that, due to its geometry and surface properties, provides for movement of a liquid sample therethrough via capillary action.

As used herein “capillary action” refers to the generation of liquid flow only by virtue of surface tension of the liquid. Such liquid flow can be established without the need to apply mechanical or other force to the liquid, and in the absence of any vector component of the gravitational force in the direction of the flow.

In some embodiments of the present invention capillary structure is selected to provide for movement of the deposited liquid therethrough and to retain the deposited liquid therein, such that a gas does not penetrate into the capillary structure.

In some embodiments of the present invention the embossed structures include at least one structure characterized by a smallest dimension (e.g., width) which is less than 250 nm, or less than 200 nm or less than 150 nm or less than 100 nm or less than 50 nm, e.g., 20 nm or less. In some embodiments of the present invention the embossed structures include at least one, more preferably a plurality of structures characterized by a width which is narrower than the diameter of a single droplet of the deposited liquid.

According to an aspect of some embodiments of the present invention there is provided a method of printing. The method comprises: embossing a capillary structure onto a receiving layer; and depositing a liquid material to fill the capillary structure.

According to some embodiments of the invention a smallest dimension of the capillary structure is smaller than a characteristic diameter of a droplet of the liquid material during the deposition.

According to some embodiments of the invention the method further comprises embossing at least one additional structure onto the receiving layer such as to establish fluid communication between the capillary structure and the at least one additional structure.

According to some embodiments of the invention the capillary structure is an elongated capillary structure, and wherein the at least one additional structure comprises a well structure, such as to establish fluid communication between the well structure and the elongated capillary structure.

According to some embodiments of the invention a width of the elongated capillary structure is smaller than a characteristic diameter of a droplet of the liquid material during the deposition, and wherein smallest dimension of the well structure is larger than the characteristic diameter of the droplet.

According to some embodiments of the invention the depositing is performed onto the at least one additional structure and wherein the capillary structure draws the liquid from the at least one additional structure through the fluid communication via a capillary action.

According to some embodiments of the invention the method further comprises: coating the capillary structure once filled with the liquid material by additional receiving layer; and repeating the embossing and the depositing at least once thereby forming a multilayer printed product.

According to some embodiments of the invention the receiving layer comprises a sol gel. According to some embodiments of the invention the receiving layer comprises a UV curable material. According to some embodiments of the invention the receiving layer comprises a heat curable material. According to some embodiments of the invention the receiving layer comprises a spin on glass material.

According to some embodiments of the invention the deposited liquid comprises ink. According to some embodiments of the invention the deposited liquid comprises an electrically functional ink. According to some embodiments of the invention the ink comprises nanoparticle solution. According to some embodiments of the invention the functional ink comprises a solution which when solid is a semiconductor. According to some embodiments of the invention the solution comprises a silane.

According to some embodiments of the invention the deposited liquid comprises insulator liquid. According to some embodiments of the invention the insulator liquid comprises a spin on glass. According to some embodiments of the invention the insulator liquid comprises a sol gel. According to some embodiments of the invention the insulator liquid comprises an insulating polymer.

According to an aspect of some embodiments of the present invention there is provided a printed product producible by the method described herein. According to an aspect of some embodiments of the present invention there is provided a multilayer printed product producible by the method described herein.

According to an aspect of some embodiments of the present invention there is provided a transistor producible by the method described herein.

According to an aspect of some embodiments of the present invention there is provided a circuitry producible by the method described herein.

According to an aspect of some embodiments of the present invention there is provided a printed product. The printed product comprises an arrangement of printed features on a carrier layer, wherein at least one of the printed features comprises an ink material filling a capillary feature being embossed onto the carrier layer.

According to some embodiments of the invention a width of the at least one printed features is less than 200 nm.

According to some embodiments of the invention a spacing between two adjacent printed features is of less than 2 microns.

According to some embodiments of the invention the arrangement of printed features forms a transistor.

According to some embodiments of the invention the arrangement of printed features forms a circuitry.

According to some embodiments of the invention the printed features are arranged in a plurality of layers.

According to an aspect of some embodiments of the present invention there is provided a system for fabricating a printed product. The system comprises: an embossing system configured for embossing a capillary structure onto a receiving layer; and a printing system for depositing a liquid material to fill the capillary structure.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic diagram showing an embossing technique.

FIGS. 2A-C are schematic diagrams showing an ink jet head, ink jetting liquid droplets into an embossed capillary feature.

FIGS. 3A-F are schematic layouts of the process steps for forming a high resolution all-additive printed electronics circuit (thin film transistor circuit) using a single layer of capillary embossing.

FIG. 4 is a schematic diagram showing how circuitry formed using a single layer of capillary embossing may be laid out to comprise a more complex circuit comprising multiple thin film transistors cascaded together.

FIGS. 5A-F are schematic layouts of the process steps for forming a high resolution all-additive printed electronics circuit (thin film transistor circuit) using two layers of capillary embossing.

FIG. 6 is a schematic diagram showing how circuitry formed using a two layers of capillary embossing may be laid out to comprise a more complex circuit comprising multiple thin film transistors cascaded together.

FIG. 7 is a schematic illustration of a system for fabricating a printed product, according to some embodiments of the present invention.

### DESCRIPTION OF SPECIFIC EMBODIMENTS OF THE INVENTION

The present invention, in some embodiments thereof, relates to printing and, more particularly, but not exclusively, to printing by capillary embossing.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

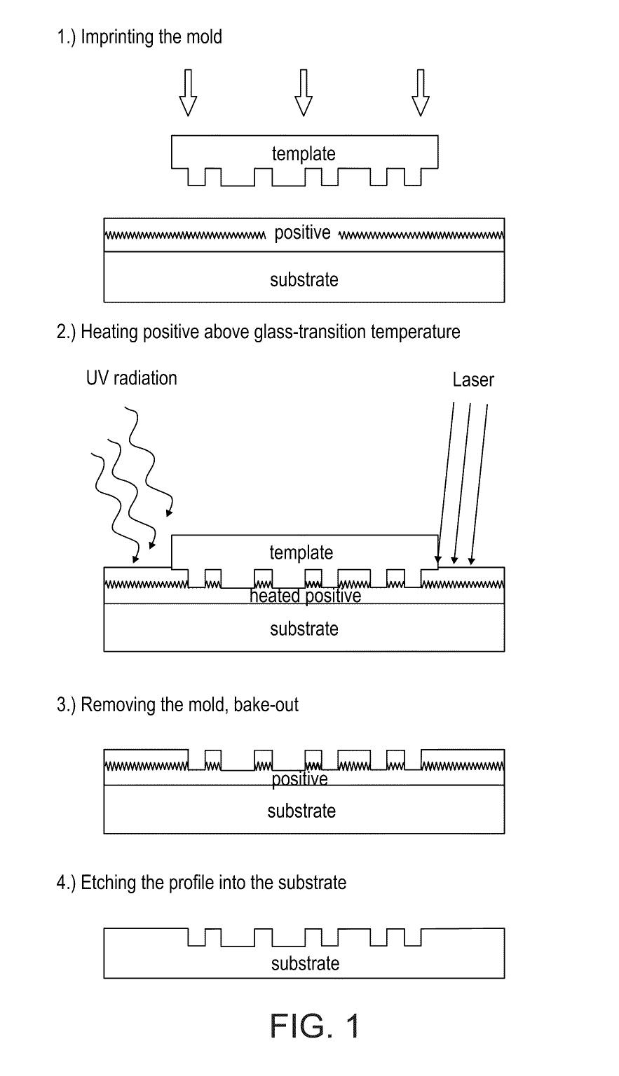

FIG. 1 is a schematic illustration shows a schematic diagram showing an existing embossing technique.

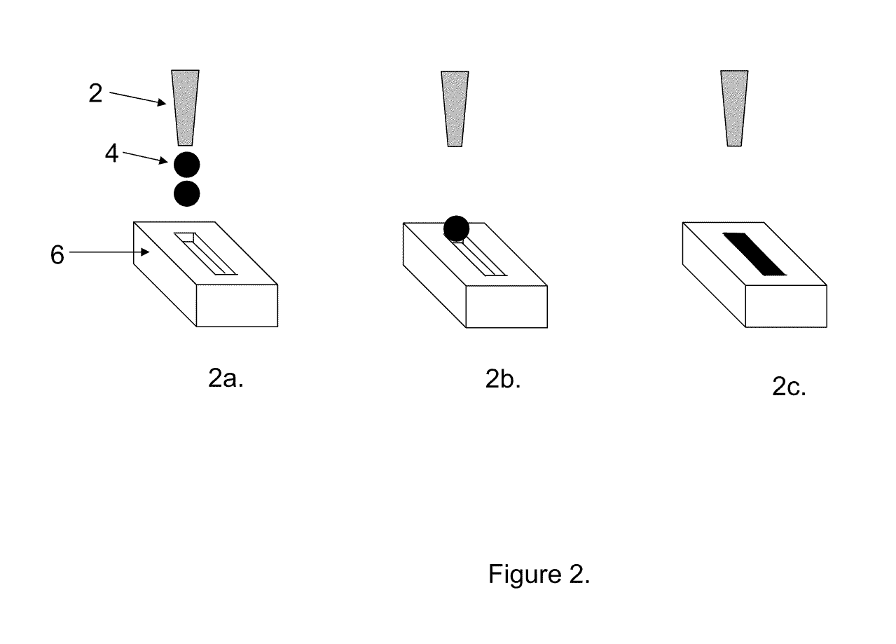

FIG. 2 is a schematic diagram showing an ink jet head 2 ink jetting liquid droplets 4 into an embossed capillary feature 6, according to various exemplary embodiments of the present invention. A particular feature of this process is the resulting liquid pattern, as shown in FIG. 2c, which can have a width narrower than the diameter of the original ink jet droplet 3. The length of a capillary feature which can be fully filled with liquid from the ink jet is given by the capillary action equations as is known in the theory of capillary forces. For example, in some embodiments of the invention, the length L of the capillary feature satisfies: L<2γ Cos (θ)/(ρ g w), where γ is the liquid-air surface tension (in units of energy per unit area), θ is the contact angle, ρ is the density of liquid (in units of mass per unit volume), g is the gravitational acceleration (in units of length per unit time squared) and w is the width of the capillary feature.

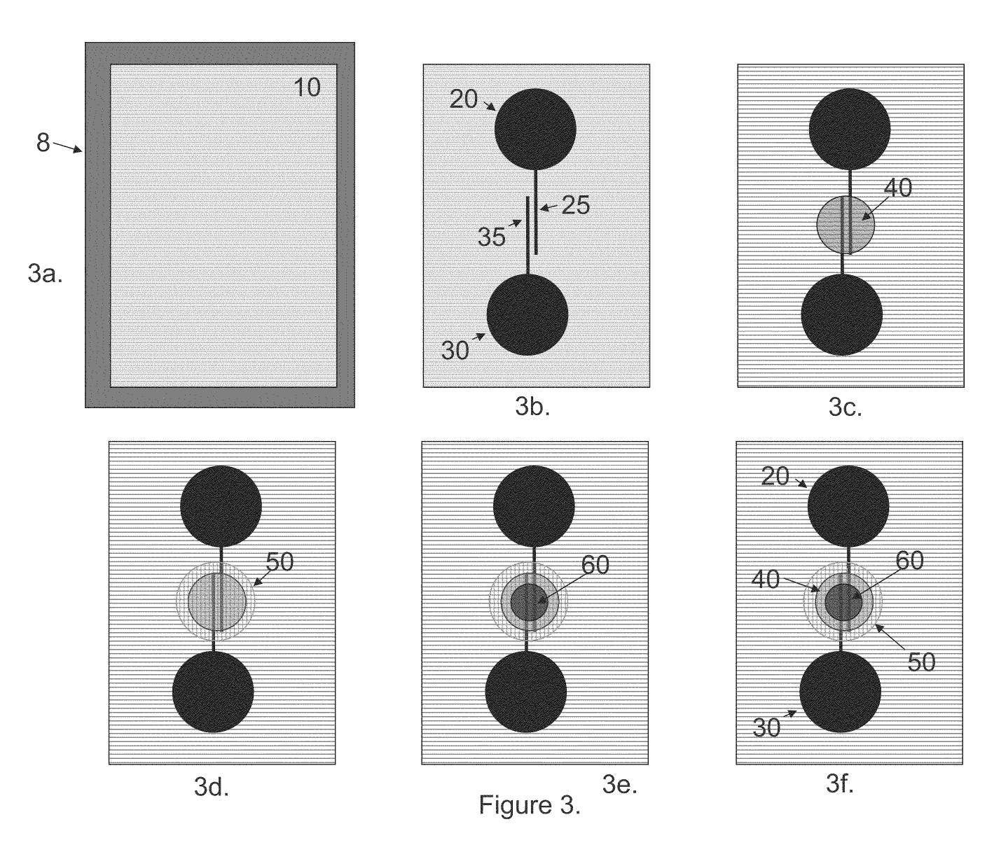

Reference is now made to FIG. 3 which is a schematic layout of a process for forming a high resolution all-additive printed electronics circuit, according to various exemplary embodiments of the present invention. The process can be used for fabricating, for example, a thin film transistor circuit. The process can employ a single layer of capillary embossing. It is to be understood that multilayer capillary embossing is not excluded.

Referring to FIG. 3a, a receiving liquid 10 is coated onto substrate 8. Receiving liquid 10 can be a sol-gel, or spin on glass, or polyimide, or any other material suitable for embossing and curing with either temperature or heat. Receiving liquid 10 is preferably a material which can be processed at temperatures suitable to cure functional ink materials which may be later deposited into features embossed in liquid material 10. Such process temperatures for inorganic functional ink materials may range from about 400 degrees C. to about 600 or to about 800 degrees C. or higher.

Substrate 8 is preferably a material which can also handle high temperatures suitable for inorganic semiconductor processing and may preferably be stainless steel foil. Note that for clarity of presentation, substrate 8 is not shown in subsequent drawings.

Once the receiving liquid is applied to the substrate, the receiving liquid is preferably embossed with structures, preferably capillary structures. This can be done using any technique known in the art. For example, in some embodiments of the present invention soft nanoimprint lithography is employed. In these embodiments, a stamp structure having thereon a stamp pattern including one or more protruding features and recesses is urged at a stamping pressure into the receiving liquid, so as to at least reduce the thickness of the receiving liquid under the protruding feature. The stamping pressure is preferably selected sufficient to transfer the stamp pattern to the receiving liquid.

The outer surface of the stamp structure is made of a stamp material which can be a conformal elastomeric material such as Polydimethylsiloxane (PDMS) or the like. Other elastomeric materials, such as, but not limited to, polyisoprene, polybutadiene, polychloroprene, polyisobutylene, poly(styrene-butadiene-styrene), polyurethanes and silicones are not excluded from the scope of the present invention.

The stamp material may form a thin layer which is adhered to a stiffer structure layer such as glass or the like in order to provide dimensional stability to the stamp over long distances.

A representative example of a process suitable for the present embodiments is the Substrate Conformal Imprint Lithography (SCIL), see, e.g., http://www.suss.com/fileadmin/files/technical_publications/WP_SUSS_SCIL_{—}210909.pdf, the contents of which are hereby incorporated by reference. The liquid which is being embossed should be a material which can stand moderately high temperatures such as a sol-gel or polyimide.

Once the structures are embossed, a liquid is deposited, e.g., by means of ink jetting, into at least one of the structures. The deposited liquid is preferably different from the receiving liquid. In various exemplary embodiments of the invention the deposited liquid is a functional liquid, e.g., a functional ink material. In some embodiments of the present invention the functional ink material is electrically functional. Representative examples of electrically functional ink materials include an electrically conductive ink material, a semiconductor ink material and an insulator ink material.

In some embodiments of the present invention the embossed structures include at least one well structure (see, e.g., feature 20 in FIG. 3, below) and at least one elongated capillary structure (see, e.g., feature 25 in FIG. 3, below) attached thereto, wherein the capillary structure has much finer dimensions (e.g., with a smallest dimension which is at least 10 times or at least 100 times smaller) than the well structure. For example, in some embodiments, the smallest dimension of the well structure is larger than d and the smallest dimension (e.g., width) of the elongated capillary structure is smaller than d, where d is the characteristic diameter of a droplet of the deposited liquid. The liquid is optionally and preferably being jetted into the well structure and is then drawn by capillary action into the capillary structure. The well structure may be a capillary structure or a non-capillary structure as desired.

The relation between the sizes of the well structure and elongated capillary structure can be formulated as follows. In various exemplary embodiments of the invention the volume of the embossed well is equal or greater than the volume of the embossed elongated capillary structure that is attached to the well. For example, when the well has a generally cylindrical shape, its volume V_{well} is πr²h where r is the radius of the well and h is the thickness of receiving liquid 10 on the substrate 8. The volume of the elongated capillary structure is approximately Lwh, where L and w are, respectively, the length and width of the elongated capillary structure. Thus, in such configuration L≦πr²/w. In addition, to ensure capillary action L preferably satisfies the aforementioned capillary condition L<2γ Cos (θ)/(ρ g w).

Reference is now made to FIG. 3b which is a schematic top down view of an embossed capillary transistor source well 20 and an electrode 25, in addition to embossed capillary transistor drain well 30 and electrode 35 which have subsequently been filled by means of ink jet with suitable conducting materials. A preferred conducting material is a nanoparticle ink such as those made by Ulvac Corporation.

Reference is now made to FIG. 3c which is a schematic top down view which has further added an inkjet deposited semiconductor feature 40. In a preferred embodiment such ink jettable semiconductor material may be a liquid silane. Such semiconductor is then typically annealed or laser annealed subsequent to deposition.

Reference is now made to FIG. 3d which is a schematic top down view which has further added an inkjet deposited insulator feature 50 which constitutes the gate oxide of the thin film transistor device. In a preferred embodiment such ink jettable insulator material may be a spin on glass or sol gel or insulating polymer. Such insulator is then typically annealed subsequent to deposition.

Reference is now made to FIG. 3e which is a schematic top down view which has further added an inkjet deposited metal feature 60 which forms the gate of the thin film transistor device. In a preferred embodiment such ink jettable gate metal may be a nanoparticle ink such as those made by Ulvac Corporation. Such gate metal is then typically annealed subsequent to deposition.

Reference is now made to FIG. 3f which shows a final thin film transistor device. Note that the spacing between source electrode 25 and drain electrode 35 is determined by the resolution of the embossing process and the laws of capillary action and not by the resolution of the ink jet droplet per se. As a typical dimension such source-drain electrode spacing may be 2 microns or less.

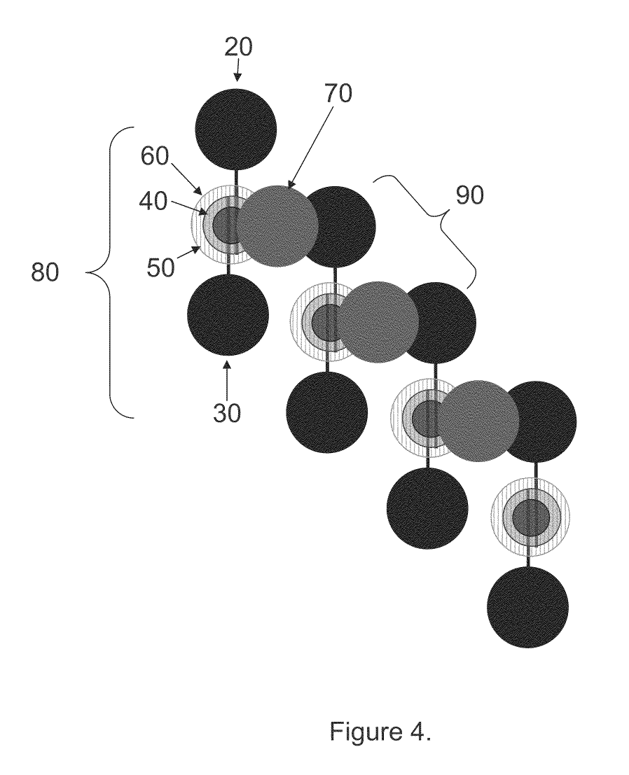

FIG. 4 is a schematic representation of a plurality of the emboss and ink jet fabricated thin film transistor devices of FIG. 3 cascaded together to build a circuitry. In the representative illustration, the circuitry is a part of a transistor ring oscillator as is known in the art of electronic circuits. Adjacent transistors can be electrically connected to each other by means of ink jet deposited conducting material droplet 70. A preferred material for such ink jettable conducting material is a nanoparticle ink such as those made by Ulvac Corporation.

The dimensions of the thin film transistor unit cell are indicated by reference signs 80 and 90. Dimension 80 can be approximately 3d where d is the diameter of an ink jet droplet. Dimension 90 can be approximately (3/2)d·2^{0.5}. Therefore, the area of the transistor unit cell for this layout is approximately 6.75 d². A typically minimal ink jet diameter may be taken to be 10 microns. Therefore a unit cell with this layout can be about 675 square microns. Thus, each 1 mm² of substrate holds approximately 1,481 transistors.

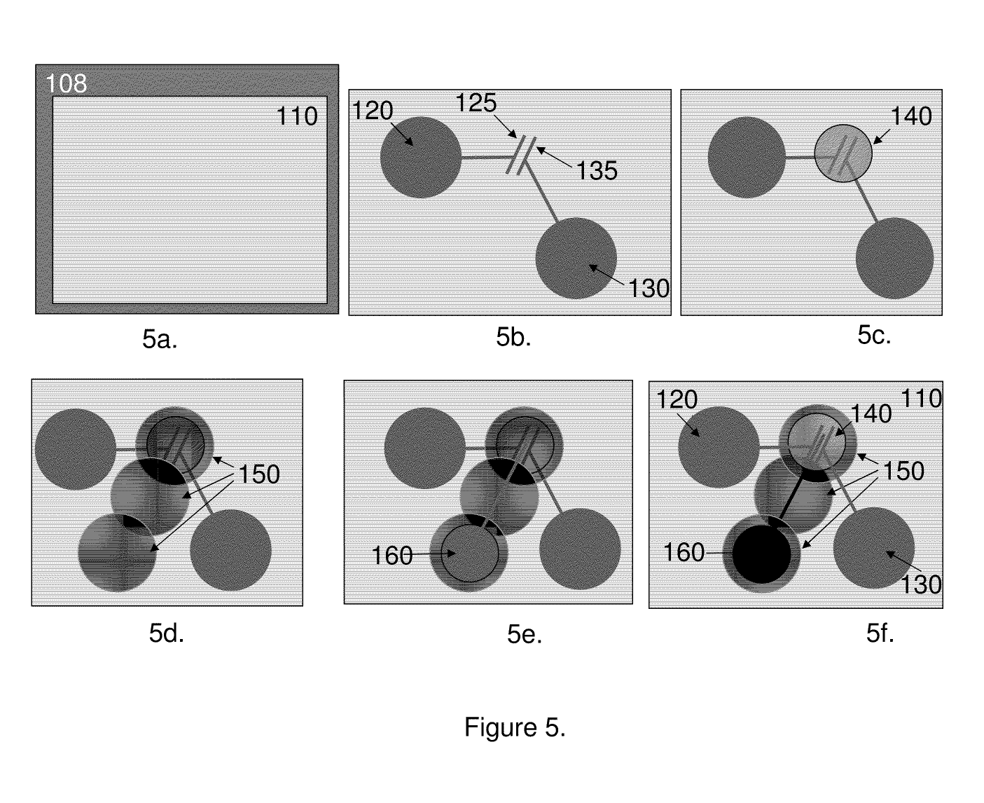

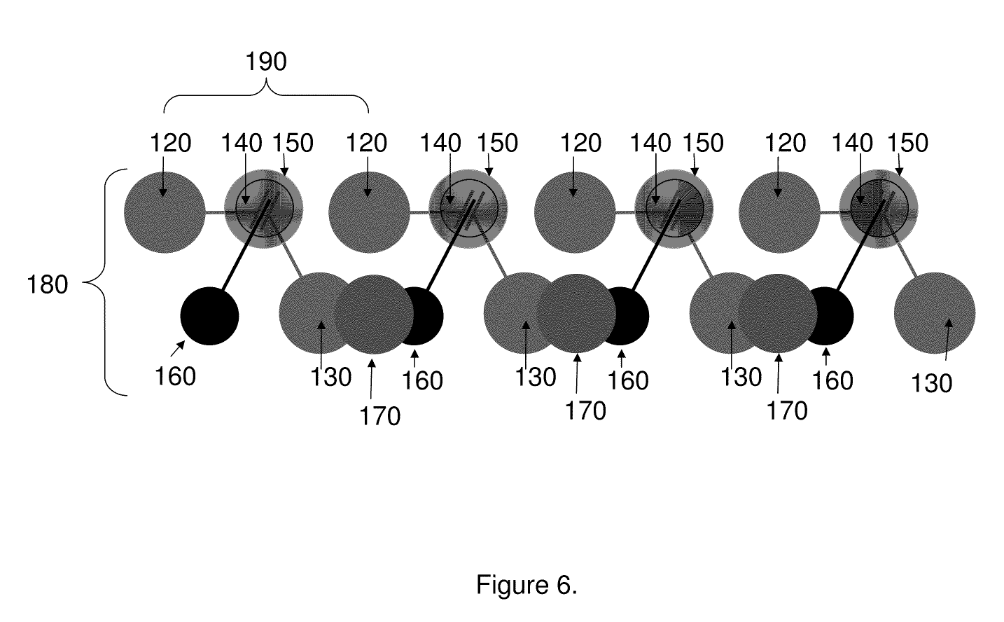

In certain cases, such as to build high performance electronic circuits it is desirable that the transistor gate electrode (e.g., reference sign 60 in FIG. 3) not overlap the source and drain electrodes (e.g., reference signs 25 and 35 in FIG. 3 respectively) but rather fall between them. This can be achieved by an additional patterning featuring an additional embossing as further detailed below with reference to FIGS. 5 and 6.

Referring to FIG. 5a, a receiving liquid 110 is coated onto a substrate 108, as further detailed hereinabove.

FIG. 5b is a schematic top down view of an embossed capillary transistor source well 120 and electrode 125 in addition to embossed capillary transistor drain well 130 and electrode 135 which have subsequently been filled by means of ink jet with suitable conducting materials. A preferred conducting material is a nanoparticle ink such as those made by Ulvac Corporation.

FIG. 5c is a schematic top down view which has further added an inkjet deposited semiconductor feature 140. In some embodiments such ink jettable semiconductor material may be a liquid silane. Such semiconductor is then typically annealed or laser annealed subsequent to deposition.

FIG. 5d is a schematic top down view which has further added an inkjet deposited set of insulator features 150 which both constitute the gate oxide in the place where it overlaps semiconductor 140 as well as constituting the second emboss receiving layer. In a preferred embodiment such ink jettable insulator material may be a spin on glass or sol gel or insulating polymer. Such insulator is then embossed with a pattern containing the gate electrode and a receiving well for said gate electrode.

FIG. 5e is a schematic top down view which has further added an inkjet deposited metal feature 160 which is jetted into the receiving well of the embossed gate electrode electrode capillary structure. In a preferred embodiment such ink jettable gate metal may be a nanoparticle ink such as those made by Ulvac Corporation. Such gate metal is then typically annealed subsequent to deposition.

FIG. 5f illustrates a final thin film transistor device. Note that the spacing between source electrode 125 and drain electrode 135 as well as the width of gate electrode 160 is determined by the resolution of the embossing process and the laws of capillary action and not by the resolution of the ink jet droplet per say. As a typical dimension such source-drain electrode spacing may be 2 microns or less.

FIG. 6 is a schematic representation of a plurality of emboss and ink jet fabricated thin film transistor devices of FIG. 5 cascaded together to build a circuitry. In the illustrated embodiment, the circuitry is part of a transistor ring oscillator as is known in the art of electronic circuits. Adjacent transistors are connected up to each other by means of ink jet deposited conducting material droplet 170. A preferred material for such ink jettable conducting material is a nanoparticle ink such as those made by Ulvac Corporation.

The dimension of the thin film transistor unit cell are indicated by reference numerals 80 and 90. Each of dimensions 80 and 90 can independently be approximately 3d where d is the diameter of an ink jet droplet. Therefore, the area of the transistor unit cell for this layout is about 9d². A typically minimal ink jet diameter may be taken to be 10 microns. Therefore, a unit cell with this layout is about 900 square microns. Hence, each 1 mm² of substrate holds approximately 1,111 transistors.

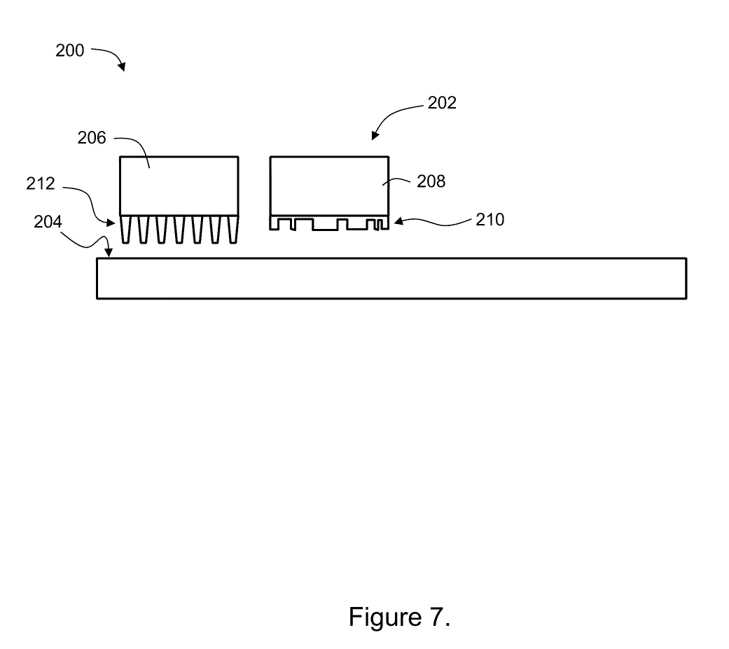

FIG. 7 is a schematic illustration of a system 200 for fabricating a printed product, according to various exemplary embodiments of the present invention. System 200 comprises an embossing system 202 configured for embossing a capillary structure onto a receiving layer 204, as further detailed hereinabove, and a printing system 206 configured for depositing a liquid material to fill said capillary structure. System 202 can include a stamp structure 208 having thereon a stamp pattern 210, as further detailed hereinabove. Printing system 206 can be an inkjet printing system with a plurality of printing nozzles 212 configured for emitting a pressurized ink jet along an axis of the printing nozzles.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of printing, comprising:
embossing a capillary structure onto a receiving layer; and
depositing a liquid material to fill said capillary structure.

2. The method of claim 1, wherein a smallest dimension of said capillary structure is smaller than a characteristic diameter of a droplet of said liquid material during said deposition.

3. The method of claim 1, further comprising embossing at least one additional structure onto said receiving layer such as to establish fluid communication between said capillary structure and said at least one additional structure.

4. The method of claim 3, wherein said capillary structure is an elongated capillary structure, and wherein said at least one additional structure comprises a well structure, such as to establish fluid communication between said well structure and said elongated capillary structure.

5. The method of claim 4, wherein a width of said elongated capillary structure is smaller than a characteristic diameter of a droplet of said liquid material during said deposition, and wherein smallest dimension of said well structure is larger than said characteristic diameter of said droplet.

6. The method of claim 3, wherein said depositing is performed onto said at least one additional structure and wherein said capillary structure draws said liquid from said at least one additional structure through said fluid communication via a capillary action.

7. The method of claim 1, further comprising:
coating said capillary structure once filled with said liquid material by additional receiving layer; and
repeating said embossing and said depositing at least once thereby forming a multilayer printed product.

8. The method of claim 1, wherein said receiving layer comprises a sol gel.

9. The method of claim 1, wherein said receiving layer comprises a UV curable material.

10. The method of claim 1, wherein said receiving layer comprises a heat curable material.

11. The method of claim 1, wherein said receiving layer comprises a spin on glass material.

12. The method of claim 1, wherein said deposited liquid material comprises ink.

13. The method of claim 1, wherein said deposited liquid material comprises an electrically functional ink.

14. The method of claim 12, wherein said ink comprises nanoparticle solution.

15. The method of claim 13, wherein said functional ink comprises a solution which when solid is a semiconductor.

16. The method of claim 15, wherein said solution comprises a silane.

17. The method of claim 1, being all-additive.

18. A printed product producible by the method of claim 1.

19. A multilayer printed product producible by the method of claim 7.

20. A transistor producible by the method of claim 1.

21. A circuitry producible by the method of claim 1.

22. A printed product, comprising an arrangement of printed features on a carrier layer, wherein at least one of said printed features comprises an ink material filling a capillary feature being embossed onto said carrier layer.

23. The printed product of claim 22, wherein a width of said at least one printed features is less than 200 nm.

24. The printed product of claim 22, wherein a spacing between two adjacent printed features is of less than 2 microns.

25. The printed product of claim 22, wherein said arrangement of printed features forms a transistor.

26. The printed product of claim 22, wherein said arrangement of printed features forms a circuitry.

27. The printed product of claim 22, wherein said printed features are arranged in a plurality of layers.

28. A system for fabricating a printed product, comprising:
an embossing system configured for embossing a capillary structure onto a receiving layer; and
a printing system for depositing a liquid material to fill said capillary structure.
